(19) United States
(12) Patent Application Publication
(10) Pub. No.: US 2012/0108465 A1
(43) Pub. Date: May 3, 2012

(54) FIBER ARRAY SENSOR

(76) Inventors: Eric B. Duoss, Urbana, IL (US); Jennifer A. Lewis, Urbana, IL (US); Avner Rothschild, Haifa (IL); Kathy Sahner, Bayreuth (DE); Harry L. Tuller, Wellesley, MA (US)

(21) Appl. No.: 12/568,127

(22) Filed: Sep. 28, 2009

(51) Int. Cl. C40B 30/10; C40B 40/18; B82Y 15/00

(52) U.S. Cl. 506/12; 506/22; 977/762; 977/902

(57) ABSTRACT

A sensor array is provided including a plurality of fibers being woven to form 3-D periodic fiber structures. A selective number of the fibers include gaseous sensing materials to detect selective gases. A plurality of spacing elements provides adequate spacing between successively arranged nano-fibers. The nano-fibers and spacing elements are arranged to form a 3-D scaffolding structure for detecting specific or combinations of gaseous analytes.

### GOVERNMENTAL SPONSORSHIP INFORMATION

This invention was made with Government support under Grant No. ECS-0428696 awarded by the National Science Foundation and under Grant No. DAAD-19-03-1-0227, awarded by the Army Research Office. The Government has certain rights in this invention.

### BACKGROUND OF THE INVENTION

The invention is related to the field of sensors, and in particular to a novel sensor array having multiple fibers such as microtubes and/or microrods forming a three-dimensional (3-D) scaffold network.

Gas sensors are of increasing interest in environmental protection, homeland security, combustion and process control and a range of other application areas including biomedical, food, etc. For example, in order to reduce ecological damage by hazardous gases, more stringent laws and regulations concerning air pollution have been introduced. According to toxicity or the degree of hazard, emission thresholds for different gas species such as NH₃, CO, volatile organic compounds (VOCs), NOx or hydrocarbons are defined. Compliance with these limits needs to be controlled precisely in applications such as safety engineering, air quality monitoring, and automotive exhaust after treatment. These types of applications provide additional commercial incentives for developing reliable, highly selective, and cost-effective sensors. In particular, the development of miniaturized sensors for portable, low-cost sensor modules that can be integrated on MEMS chips has been an increasingly active area of research.

To enable integration on miniaturized electronics for the next generation of intelligent sensor devices and arrays, a major challenge is to maintain increased sensitivity and selectivity of one sensor element despite the loss of active area and increased proximity of neighboring sensor elements. Hence, nanotechnology is the method of choice to overcome the limitations of conventional sensor films.

Inspired by the rapidly growing field of carbon nanotubes (CNT) with their exceptional properties, numerous synthesis methods to prepare quasi-1D metal oxide nanostructrures have been reported in the literature. In contrast to CNT, whose properties strongly depend on chirality (difficult to control during synthesis), the composition and electronic properties of metal oxide and other compound semiconductor structures can be controlled during the growth process. The different nano-geometries include nano-fibers, -wires, -belts, -tubes, and -springs. Due to their large surface-to-volume ratio, such nanostructures present an excellent potential for conductometric gas sensors, since the sensing effect in these devices is mostly attributed to heterogeneous catalytic reactions or adsorption processes at the sensor surface. Certain researchers have directed their attention to metal oxide nanofiber devices for gas sensing, and some predict gas sensing to be one of the first commercial application for 1D nanosystems.

Despite their promising sensor characteristics, which are related to their large surface-to-volume ratio, metal-oxide nanowires generally present the same lack of selectivity as their macroscopic counterparts. This issue can be addressed by manufacturing nanosensor arrays and applying pattern recognition procedures, choosing the same methods adopted for conventional microscale devices.

The arrangement of nanofibers into sensor arrays can be arranged to form chemiresistors or field-effect transistor configurations. These configurations are formed using either synthesis methods for metal oxide nanofibers with focus on electrospinning or traditional vapour-liquid-solid and vapour-solid growth. Without further tedious templating or alignment methods, both synthesis routes lead to unoriented fiber mats. For the preparation of arrays, special modifications and multiple steps (for each material within the array) are therefore necessary.

### SUMMARY OF THE INVENTION

According to one aspect of the invention, there is provided a sensor array including a plurality of fibers being woven to form 3-D periodic fiber structures. A selective number of the fibers include gaseous sensing materials to detect selective gases. A plurality of spacing elements provides adequate spacing between successively arranged nano-fibers. The nano-fibers and spacing elements are arranged to form a 3-D scaffolding structure for detecting specific gaseous elements.

According to another aspect of the invention, there is provided a method of detecting gaseous elements using a sensor array. The method includes a plurality of nano-fibers being woven to form 3-D fiber periodic structures. A selective number of the nano-fibers include gaseous sensing materials to detect selective gases. The method also includes arranging a plurality of spacing elements for providing adequate spacing between successively arranged fibers. The fibers and spacing elements are arranged to form a 3-D scaffolding structure for detecting specific or combinations of gaseous analytes.

### BRIEF DESCRIPTION OF THE DRAWINGS

FIG. 1 is a schematic diagram illustrating a generic overview of the invention;

FIGS. 2A-2B are SEM micrographs of the scaffold structure used in accordance with the invention;

FIGS. 3A-3B are schematic diagrams illustrating a two-probe configuration formed in accordance with the invention; and

FIG. 4 is a schematic illustrating an alternative embodiment of the two-probe configuration;

FIG. 5 is a schematic diagram illustrating the diffusion reaction model; and

FIGS. 6A-6B are graphs illustrating concentration profiles according to the diffusion-reaction model calculated for a conventional metal oxide thick film sensor as a function of operating temperature and penetration depth into the film.

### DETAILED DESCRIPTION OF THE INVENTION

The invention describes a novel 3-dimensional sensor array design prepared by a Direct-Ink-Writing (DIW) process. Multiple fibers, such as microtubes or microrods, form a 3-dimensional network, within which a plurality of different gas sensitive materials can be integrated. Since the DIW approach allows 3D scaffold preparation in a reproducible, controlled and customized manner, this design can overcome the limited sensitivity of the conventional nanofiber sensors.

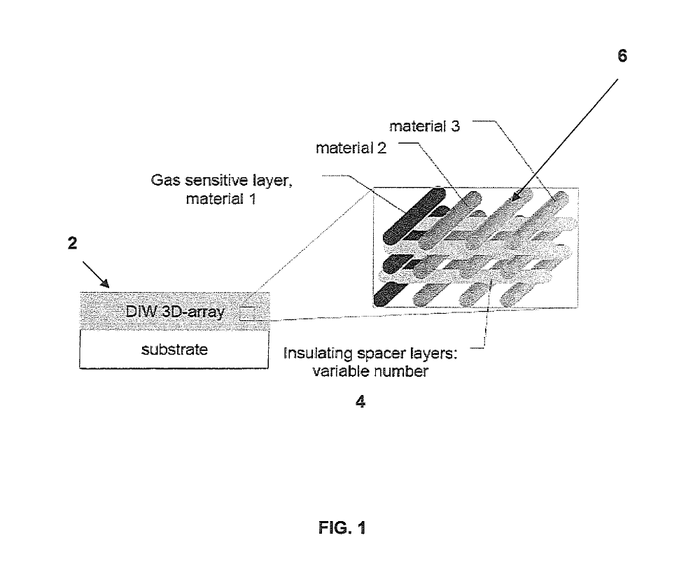

FIG. 1 shows a generic overview of the invention using a novel sensor array 2 prepared by a Direct-Ink-Writing (DIW) process and including fibers, such as multiple microtubes or microrods, forming a 3-dimensional network. A plurality of different gas sensitive materials fibers 1 can be integrated within this 3D scaffold in a reproducible, controlled and customized manner. The gas sensitive fibers are used to detect specific or combinations of gaseous analytes. The network can include metal oxide material fibers 1, 2, 3 used for gas sensitive electrical conduction pathways. This design can overcome the limited sensitivity of the conventional nanofiber sensors.

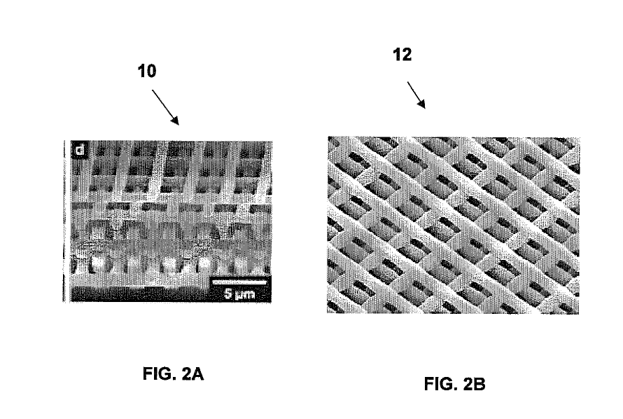

Direct ink writing (DIW) is an innovative approach for microscale patterning of planar and 3-D structures (feature sizes ranging from ˜500 nm to 10 μm) via computer-aided design. Initial efforts have focused on the development of concentrated polyelectrolyte inks capable of flowing through fine deposition nozzles as continuous filaments, and then rapidly solidifying to maintain their shape even as they span gaps in the underlying layer(s). By carefully controlling polyelectrolyte ink and reservoir compositions, patterned 3-D micro-periodic structures that serve as exquisite templates for both photonic crystals and inorganic (SiO₂)-organic hybrids can be fabricated. Recently, this technique has been expanded to various metal oxide-based, sol-gel inks that can be printed directly in air through micro-capillary nozzles for patterning structures with arbitrary complexity. These inks open up new avenues for direct-write assembly of functional 3-D micro-periodic structures, e.g., gas sensors and photonic crystals. A unique feature of the DIW process is the ability to arrange the one-dimensional fibers in 2D and 3D, thereby creating fiber arrays and 3D scaffolds as shown in FIG. 2A-2B.

Hence, the DIW features enable individual sensor wires to be woven into 3-dimensional structures. To prepare customized 3D sensor arrays integrated within a single scaffold structure, individual fibers or layers within the 3D structures are prepared from different metal oxides such as ZnO, TiO₂, SnO₂, and In₂O₃ (other p- and n-type semiconductors may also be used as well as solid solution systems). In vertical direction with respect to the substrates, these sensitive fibers 1, 2, 3 are separated by spacer layers 4 prepared from an insulating material such as Al₂O₃ as shown in FIG. 1. But in other embodiments other insulating materials can be used. The number of spacer layers 4 can vary from a minimum of one to multiple layers. In lateral direction, the sensitive metal oxide fibers 1, 2 can be either nearest neighbors, or separated by insulating spacers 6 as in the case of metal oxide fibers 2, 3. Hence, sensor response measurements can be conducted within individual metal oxide layers located at different positions within the scaffold.

The fibers can be made hollow to form microtubes or solid to form microrods. Also, the fibers can be formed to have control porosity with relative density between 60% and 90% as well as being completely dense. These fibers can have diameters ranging between 100 nm and 100 μm.

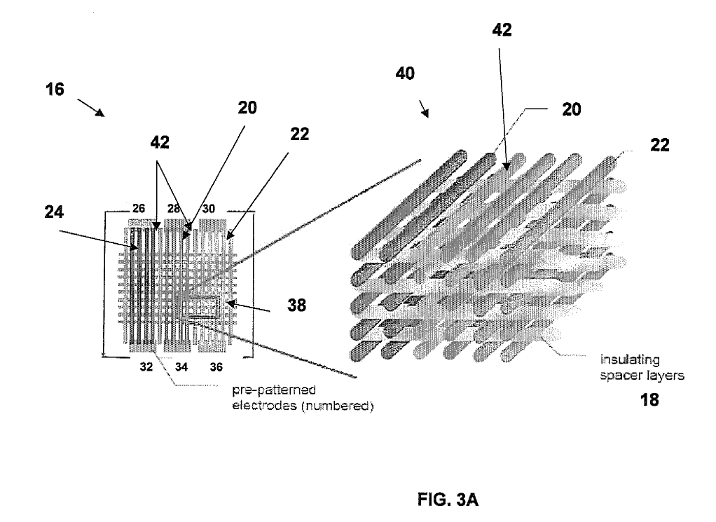

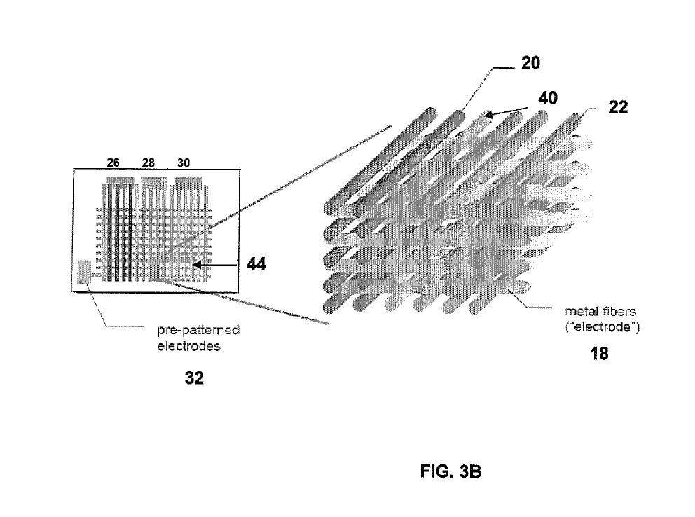

The two-probe configuration 16 shown in FIG. 3A can be used for either DC or AC conductometric measurement. A number of electrodes 26-36 can be patterned on either side of the scaffold to enable measurements on the different types of metal oxide microtubes 20, 22 and 24. A region 38 is expanded to illustrate the details of the scaffold 42. The gas sensitive material layers 20, 22 and 24 are positioned in selected areas on the configuration 16 to form the scaffold 42. In addition, one could envision replacing some of the insulating spacer fibers 18 by metal lines to provide electrical connection while at the same time minimizing the total number of electrodes. Also, laterals spacers 42 are used to laterally separate the material layers 20, 22, 24. This configuration is shown in FIG. 3B. In this case, electrode 32 is common to all fibers. The region 44 is expanded to show material layers 20 are addressed via electrodes 28 and 32, material layer 22 are addressed via electrodes 30 and 32, where the spacer fibers 18, 42 include metal fibers associated with electrode 32. The different data sets (one per interwoven oxide) are then treated by conventional pattern recognition algorithms.

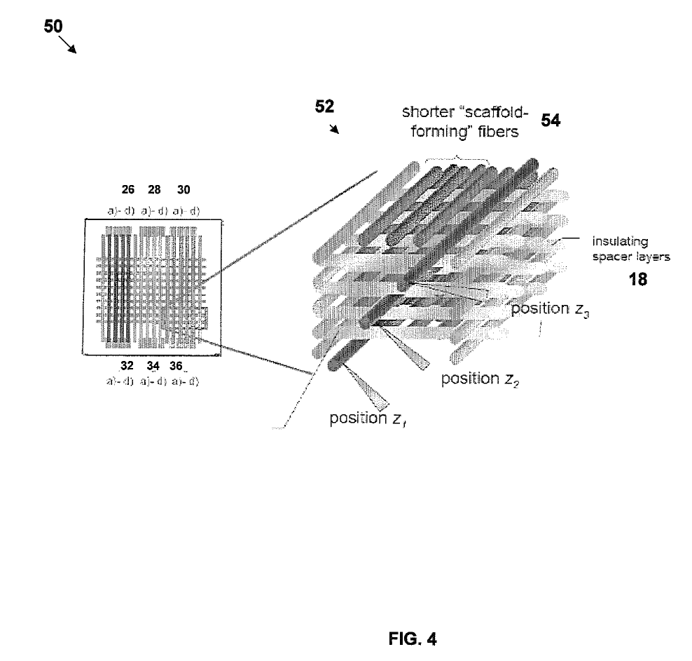

FIG. 4 shows an alternative design 50 of the 3D-scaffold, which enables selective contact to individual fibers located at different positions within the scaffold 52. As in the previous case, the substrate used for the DIW process has been previously patterned with electrode structures 26-36 of the desired electrode dimensions/materials, e.g. by photolithography. In contrast to the approach mentioned above, the fibers are not measured as an interconnected entity, but it is possible to probe individual fibers that are located within a different depth zᵢ of the scaffold 52. For this purpose, the basic scaffold is formed by shorter fibers 54, and only the selected fibers are extended during the DIW process to touch the contact pads. A supporting framework formed by the insulating spacer 18 prevents the extended fibers to short to deeper-lying layers. As an alternative to conventional contact pads 32-36, micro-tips 32(a-d)-36(a-d), similar to the ones used to electrically contact microelectrodes, can be used to contact the individual fibers directly. In addition, metal fibers can be inserted within the framework structure to provide contact as described above in FIG. 3B.

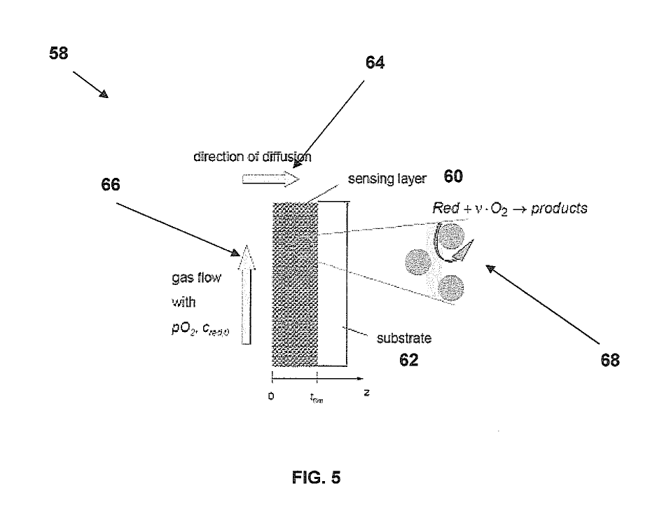

In contrast to conventional nanofiber arrays discussed herein, DIW presents a tool to reproducibly integrate multiple oxides with well-defined, near identical fiber dimensions within one single 3D structure, thereby facilitating a reliable pattern recognition process. An additional gain in selectivity can be achieved by making use of the different positions within the stack. Model calculations for conventional thick and thin film metal oxide sensors predict the sensor response to depend on film thickness (so-called “diffusion-reaction model”). This thickness effect depends on the metal oxide, the microstructural features of the film (porosity), and on the nature of the gas (reactivity). To highlight this, the diffusion-reaction model 58 for the model structure is discussed as shown in FIG. 5.

In particular, FIG. 5 shows the diffusion-reaction model 58 that includes a substrate 62 and a sensing layer 60 formed on the substrate 62. The gas flow 66 permits parallel diffusion 64 into the sensing element 60 producing a redox reaction that is shown by inset 68 illustrates the presence of a selective gas being diffused in the sensing element 62.

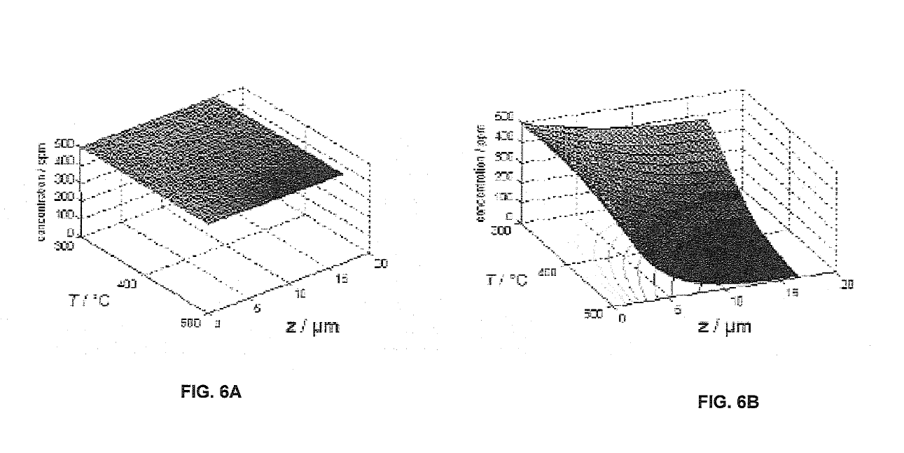

As stated above, sensor response in semiconducting metal oxide devices are often attributed to a surface reaction process. If the sensor film presents a certain degree of porosity, a parallel diffusion process into the film structure needs to be considered. In the case of less reactive gases, the analyte diffuses with nearly no consumption by reaction, and its concentration therefore varies little through the film depth, as shown in FIG. 6A.

As a consequence of this constant concentration profile, the effect of the analyte on local conductivity is the nearly the same anywhere in the sensor film. Hence, the sensor response should depend little on film thickness or distance into the scaffold. If the gas is more reactive, its concentration decays as a function of film depth, and a concentration gradient develops. The topmost layers are affected by a higher local analyte concentration than the bottom part of the sensor film or scaffold, as shown in FIG. 6B.

Thus, if one can probe individual wires located at different film positions and apply an appropriate model (and/or pattern recognition), one can discriminate different gases. By using multiple metal oxides within a three dimensional structure, the information input for pattern recognition thus increases (number of data sets=number of interwoven oxides times number of probed fiber positions). Thus, the inventive 3D scaffold array can distinguish between gases by detecting whether they have reacted at the outer layers and intermediate layers before subsequently diffusing through the scaffold to reach specific gas sensitive wires. This is accomplished by coating some of the outer wires with specific catalysts.

In addition to practical benefits as highly selective gas sensors, the DIW sensor arrays could serve as model structures to validate the theoretical diffusion-reaction models for conventional thick film and thick film metal oxide sensors proposed herein. The dependency of sensor response on layer thickness could be determined simultaneously using one single DIW specimen.

Although the present invention has been shown and described with respect to several preferred embodiments thereof, various changes, omissions and additions to the form and detail thereof, may be made therein, without departing from the spirit and scope of the invention.

What is claimed is:

1. A sensor array comprising:
a plurality of fibers being woven to form 3-D periodic fiber structures, a selective number of said fibers comprise gaseous sensing materials to detect selective gases; and
a plurality of spacing elements for providing adequate spacing between successively arranged fibers, said fibers and spacing elements are arranged to form a 3-D scaffolding structure for detecting specific or combinations of gaseous analytes.

2. The sensor array of claim 1, wherein said fibers comprise different metal oxides.

3. The sensor array of claim 1, wherein said fibers comprise doped materials systems.

4. The sensor array of claim 2, wherein as different metal oxides comprise TiO₂, SnO₂, ZnO or In₂O₃.

5. The sensor array of claim 3, wherein said doped material systems comprise p-type or n-type semiconductors.

6. The sensor array of claim 1, wherein said spacing elements comprises insulating materials or metal fibers.

7. The sensor array of claim 1, wherein said fibers and said spacing elements are configured to operate in a two-probe configuration, wherein said fibers are coupled to different electrodes.

8. The sensor array of claim 1, wherein said fibers and said spacing elements are configured to operate in a two-probe configuration, wherein said fibers share one electrode.

9. The sensor array of claim 1, wherein said fibers and said spacing elements are configured to operate in a two-probe configuration, wherein a selective number of longer length nano-fibers are coupled to individualized electrodes.

10. The sensor array of claim 1, wherein said fibers comprise microrods or microtubes.

11. The sensor array of claim 1, wherein said fibers are dense or have controlled porosity.

12. The sensor array of claim 11, wherein said controlled porosity comprises a relative density between 60% and 90%.

13. The sensor of claim 1, wherein said fibers comprise diameters between 100 nm and 100 μm.

14. A method of detecting gaseous elements using a sensor array comprising:
providing a plurality of fibers being woven to form 3-D periodic fiber structures, a selective number of said fibers comprise gaseous sensing materials to detect selective gases; and
arranging a plurality of spacing elements for providing adequate spacing between successively arranged fibers, said fibers and spacing elements are arranged to form a 3-D scaffolding structure for detecting specific or combinations of gaseous analytes.

15. The method array of claim 14, wherein said fibers comprise different metal oxides.

16. The method array of claim 14, wherein said fibers comprise doped materials systems.

17. The method array of claim 15, wherein as different metal oxides comprise TiO₂, SnO₂, ZnO or In₂O₃.

18. The method array of claim 16, wherein said doped material systems comprise p-type or n-type semiconductors.

19. The method array of claim 14, wherein said spacing elements comprises insulating materials or metal fibers.

20. The method array of claim 14, wherein said fibers and said spacing elements are configured to operate in a two-probe configuration, wherein said fibers are coupled to different electrodes.

21. The method array of claim 14, wherein said fibers and said spacing elements are configured to operate in a two-probe configuration, wherein said fibers share one electrode.

22. The method array of claim 14, wherein said fibers and said spacing elements are configured to operate in a two-probe configuration, wherein a selective number of longer length fibers are coupled to individualized electrodes.

23. The method array of claim 14, wherein said fibers comprise microrods or microtubes.

24. The method array of claim 14, wherein said fibers are dense or have controlled porosity.

25. The method array of claim 24, wherein said controlled porosity comprises a relative density between 60% and 90%.

26. The method of claim 14, wherein said fibers comprise diameters between 100 nm and 100 μm.
